(19) United States
(12) Patent Application Publication
(10) Pub. No.: US 2007/0251164 A1
(43) Pub. Date: Nov. 1, 2007

(54) Liquid window shade

(76) Inventor: Zoltan Egeresi, Santa Cruz, CA (US)

Correspondence Address: ZOLTAN EGERESI, 5500 COAST ROAD, SANTA CRUZ, CA, 95060, US

(21) Appl. No.: 11/412,246

(22) Filed: Apr. 27, 2006

(51) Int. Cl. E06B 7/00

(52) U.S. Cl. 52/171.3

(57) ABSTRACT

The Liquid Window Shade is a sealed double glazed window comprises of two spaced panes of glass sealed in a frame with spacer with sealed holes for connecting hoses for dyed water or other colored liquid to be pumped in or re-circulated, to block light coming in or decrease it to increase privacy, UV filtering or decrease heat loss. Air pump is to create a stream of air curtain inside the enclosure using several holes in the air strip located on the bottom. Draining solenoid, liquid and air pump connected to a timer creates an automated “shade up, shade down” cycle. Different colors, waterproof confetti, UV filtering chemicals can be added, for seasonal changes, for parties, or creating a falling snow flake affect.

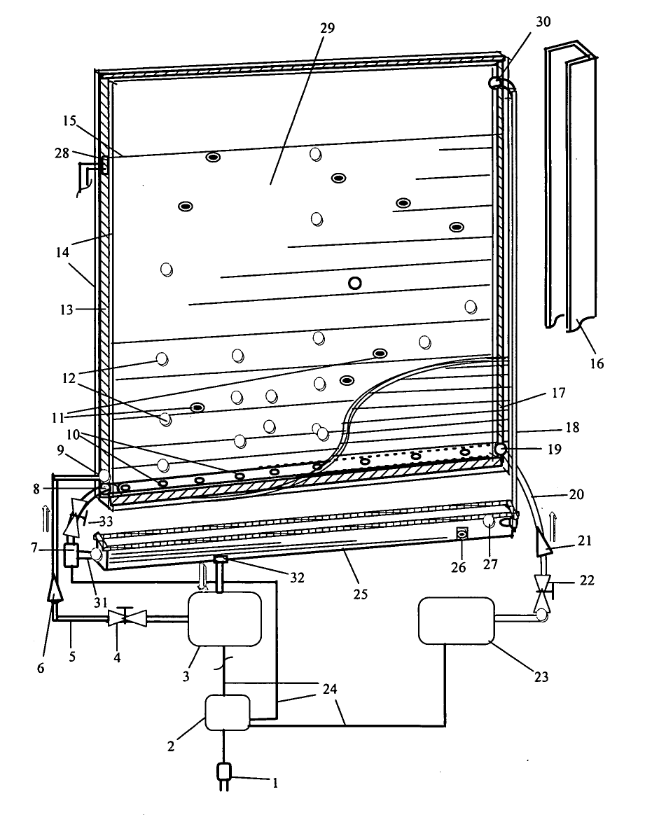

### CROSS REFERENCE RELATED APPLICATIONS

U.S. Pat. No. 6,932,139 by Early teaches a mechanically movable blind with magnets in a sealed double window. U.S. Pat. No. 4,459,778 by Ball uses a movable blind between two sealed plain glasses. An another version of the mechanical movable enclosed blind is explained by Jelic in U.S. Pat. No. 5,826,638.

### FEDERALLY SPONSORED RESEARCH AND DEVELOPMENT

Not applicable

### BACKGROUND OF THE MENTION

### Field of the Invention

This invention relates to window shading, US patent classification 160/107, 160/84.6. My invention improves insulation against heat loss, provides shade from sunlight, provides privacy, never needs any dusting. All current shades are solid materials, such as plastic, cloth, wood. To prevent dust collection on the blinds, newer innovations use enclosed tilt-able blinds between sealed double glazed windows and various complicated ways to tilt and move the blinds and over time they are subject to fading, discoloration. My invention is a sealed double glazed window comprises two spaced panes of glass sealed in a frame with colored liquid with UV protection, small pump pumps in the fluid as preset by a timer to function as a controlled automated “Liquid Shade”. No moving parts, no fading material, no dust collection, improved thermal protection. Air and confetti can be mixed in with different colored, dyed water to create special holiday feeling, increase shading effect instead of using mechanically movable blind.

### BRIEF SUMMARY OF THE INVENTION

The object of this invention is to create a novel Liquid Window Shade, colored liquid using dye or other UV protective chemicals, where a pump is capable of circulating said liquid between two sealed windows panels. Air pump can add additional shielding effect with bubbles injected from the bottom steaming up with optional waterproof confetti. Color or fluid density can be easily changed as season may require it, party and holiday effects can be created, like light blue fluid with white flakes and air for Christmas.

No blinds need to be dusted, turned, tilted, simple timer controlled fluid circulation replaces need for any complicated electro mechanical shade control to give the occupied home feeling for safety and security, this “liquid blind” does not fade.

### BRIEF DESCRIPTION OF THE INVENTION

A sealed double glazed window (14) comprises of two spaced panes of glass sealed in a frame with spacer (13) with sealed holes for dyed liquid (29), air (19) to enter.

Fluid is contained in the bottom pan (25), timer (2) activates water pump (3) and or air pump (23) to pump in the liquid into the sealed windows enclosure (14). The spacer between the two pane of glass provides hermetic seal of the window unit, it has a hole (9, 19) for liquid and air inlets, draining is at (8) into the liquid container (25).

### DETAILED DESCRIPTION OF THE INVENTION

My invention comprises of a hermetically sealed double glazed window (14), two separated panes of glass sealed in with a frame (16) with spacer (13), at the bottom holes (9) are located to conduct liquid from the pump (3) to fill the space between the window panes. Liquid return flow is trough drain outlet (8) return line (31) via valve (33) and solenoid (7 to the liquid container (25) preferably located just in front of the Liquid Window Shade having enough capacity to hold the liquid required for the total in between window space volume. When the fluid container (25) is full, power coming from connector (1) trough timer (2) with one of the three controlled output turns on water pump using AC cable (24), colored/dyed fluid exits at the bottom of the liquid tank (25) at connection (32) via hose (5), adjusting valve (4), check valve (6) trough connection (9) pumping liquid into the hermetically sealed space (29). Timer (2) has at least three controlled outputs with manual override to be able to turn on and off liquid, air or solenoid as to set up liquid level, and special effects. Timer should be on till the window space is filled with liquid or until water level (15) reaches lever sensor (28) as it shuts the pump off, or liquid gets re-circulated trough overflow hole (30). When user wants to change color, or type of liquid, it can be drained off when drain switch (33) is opened and drain solenoid (7) is activated, open.

By using the timer to set up the liquid pumping time and set timing to open solenoid to drain the Window “pulling away the shade” the function of the automated Liquid Window Shade can be achieved as the length of shading time can be programmed.

To set up the special effect of the invention the timer (or manual) controlled air pump (23) trough air hose (20), air volume valve control (22), check valve (21) air hole (19) air can be pumped in to sealed enclosure to create a bubble curtain as the bubbles (12) leave trough air holes (10), these bubbles can also steer up the water proof confetti (11) for additional shading or creating a snow fall effect. The liquid container (25) can be drained trough draining hole (26) and filled up at opening (27).

Liquid may also be replaced by theatrical fog, in this case the fog generator would replace the water and air pump re-circulating the fog making material.

In respect, after explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. It is important, therefore, that the claims be regarded as including such equivalent constructions insofar as they do not depart from the spirit and scope of the present invention, nor is it intended to be limiting as to the scope of the invention in any way.

What I claim as my invention is Liquid Window Shade comprising of:

1. A hermetically sealed pair of glass enclosed in a frame with inner space capable to be filled with dyed or colored liquid, water, mineral oil or other liquid chemicals or theater fog providing capabilities to reduce heat loss and limit or block light, block or reduce UV light or sunlight to get trough to provide privacy;
a. The insulation between the panes having several hose connection for liquid to be pumped in, liquid be drained, overflow connection for liquid or theatrical fog re-circulation, air hose connection, liquid sensor for level control;
b. An air pump with a volume controller controlled by a timer or manually activated, capable of pumping sufficient amount of air into the bottom of the Liquid Window Shade to crate an air bubble stream, additional shading effect and steer up waterproof confetti, check valve providing protection against fluid entering into the air pump;
c. A shut off valve to prevent liquid back flow to the container if closed-manual operation-, with open valve the solenoid in the liquid return line is opened by the timer providing timed, automated draining, shade controlling;
d. A liquid container having sufficient capacity to hold enough liquid for the window's inner space, connection for drain return line, pump, overflow return line, for container filling.
